(19) United States
(12) Patent Application Publication
(10) Pub. No.: US 2026/0036504 A1
(43) Pub. Date: Feb. 5, 2026

(54) WATER-RICH HIGH-GEOSTRESS STRIKE-SLIP FAULT SIMULATING TEST CHAMBER AND USE METHOD THEREOF

(71) Applicant: Jianghan University, Wuhan (CN)

(72) Inventors: Longjun XU, Wuhan (CN); Jiaxin HAN, Wuhan (CN); Xiangwen FENG, Wuhan (CN); Yuxuan LU, Wuhan (CN); Heng ZHANG, Wuhan (CN)

(73) Assignee: Jianghan University, Wuhan (CN)

(21) Appl. No.: 19/353,783

(22) Filed: Oct. 9, 2025

(30) Foreign Application Priority Data
Oct. 10, 2024 (CN) 202411407436.2

(51) Int. Cl. G01N 3/56; G01N 3/12; G01V 1/30

(52) U.S. Cl. CPC G01N 3/567; G01N 3/12; G01V 1/307; G01N 2203/0044; G01N 2203/0048; G01N 2203/0206; G01N 2203/0232; G01N 2203/0242; G01N 2203/0274

(57) ABSTRACT

A water-rich high-geostress strike-slip fault simulating test chamber includes a first chamber and a second chamber. A flexible chamber is fixedly connected between the first chamber and the second chamber; the flexible chamber includes a plurality of flexible fault connecting units; each of the flexible fault connecting units includes framework flanges, a rubber ring, and a steel plate nested in the rubber ring; the framework flanges are respectively fixed at two axial sides of the rubber ring; and two adjacent flexible fault connecting units are connected through a bolt device fixed on two adjacent framework flanges. According to the present disclosure, the flexible chamber includes a plurality of flexible fault connecting units. The framework flanges are configured to connect the plurality of flexible fault connecting units. The rubber ring is able to realize axial tensile deformation and horizontal shear deformation, as well as a sealing function under pressure.

### CROSS-REFERENCE TO RELATED APPLICATIONS

This application claims priority to Chinese Patent Application No. 202411407436.2 with a filing date of Oct. 10, 2024. The content of the aforementioned application, including any intervening amendments thereto, is incorporated herein by reference.

### TECHNICAL FIELD

The present disclosure relates to the research and development field of strike-slip fault simulating test chamber devices for fracture zones and the field of water-rich high-geostress simulation tests, and in particular to a water-rich high-geostress strike-slip fault simulating test chamber and a use method thereof.

### BACKGROUND

Due to complex geological conditions and strong fault activities of high geostress areas, extremely high technical requirements are imposed on design, manufacture and installation of devices in the high geostress areas. For example, most existing high-geostress simulation test devices employ square chambers to pressurize tested soil and rock in horizontal and vertical directions. However, due to complexity of the high geostress in reality, the pressurization from either only the horizontal or the vertical directions is difficult to simulate real conditions comprehensively. Moreover, most existing high-geostress test devices can adapt to only relatively simple environmental conditions, but cannot simulate pressurization in more complex environments. For example, during simulation tests on subsea tunnel excavation, positioning the soil in a water-rich environment is crucial, but the existing test devices cannot simulate this environment. Therefore, to develop a test device that can implement pressurization in more directions and can realize experimental research in more complex environments and conditions is a problem to be solved urgently.

### SUMMARY OF PRESENT INVENTION

An objective of the present disclosure is to provides a water-rich high-geostress strike-slip fault simulating test chamber and a use method thereof, to solve the problems in the prior art.

An embodiment of the present disclosure provides a water-rich high-geostress strike-slip fault simulating test chamber, including: a first chamber and a second chamber, where a flexible chamber is fixedly connected between the first chamber and the second chamber; the flexible chamber internally communicates with the first chamber and the second chamber; the flexible chamber includes a plurality of flexible fault connecting units; each of the flexible fault connecting units includes framework flanges, a rubber ring, and a steel plate nested in the rubber ring; the framework flanges are respectively fixed at two axial sides of the rubber ring; and two adjacent flexible fault connecting units are connected through a bolt device fixed on two adjacent framework flanges; and

a base is disposed under each of the first chamber, the second chamber and the flexible chamber; a roller assembly is jointly disposed under every two adjacent framework flanges in the flexible chamber; the roller assembly includes at least one roller; a slide rail is disposed on the base disposed under the flexible chamber; the slide rail is in one-to-one correspondence with the roller assembly; and the roller in the roller assembly is mated with the slide rail.

Further, the first chamber and the second chamber have an identical structure, and each is a quasi-cylinder with one hemispherical sealed end and a truncated open end; the open end is fixedly connected to a flange connected to the flexible chamber; the sealed end is provided with a gas connection opening and a water connection opening that communicate with an interior of the quasi-cylinder; the gas connection opening is configured to connect with an external gas pump to pump a gas into the quasi-cylinder for pressurization; and from the water connection opening is configured to connect with an external water source to inject water into the quasi-cylinder.

Further, the first chamber and the second chamber each are disposed on the respective base through a support assembly; and the support assembly includes two support frames respectively disposed at the sealed end and the open end and a base frame connected to the two support frames.

Further, the roller assembly further includes a side frame; an upper portion of the side frame is shaped as an arc matching with a radian of each framework flange, and fixedly connected to the framework flange through the bolt device in an arc region; and a plurality of rollers are collinearly disposed on a lower portion of the side frame.

Further, the slide rail has an I-shaped cross-section; a groove is formed in a tread of each roller; and an upper end of the slide rail is embedded into the groove of the roller, such that the roller moves linearly in a horizontal direction along the slide rail.

Further, the steel plate extends vertically in the rubber ring.

A use method of the water-rich high-geostress strike-slip fault simulating test chamber includes:
erecting the open end of the first chamber upward with a hoisting beam, filling tested soil from an opening of the first chamber, and disposing the flexible chamber and the second chamber in sequence; and
upon completion of filling, fully sealing the whole water-rich high-geostress strike-slip fault simulating test chamber, and horizontally placing the water-rich high-geostress strike-slip fault simulating test chamber on a shaking table for a test, where the base under the first chamber and the base under the flexible chamber are fixed, while the base under the second chamber is disposed on the shaking table; and a gas may be filled to each of the first chamber and the second chamber through the gas connection opening to pressurize the tested soil and water may be injected into each of the first chamber and the second chamber through the water connection opening to realize a water-rich environment; and
during the test, the base under the second chamber moves in a horizontal direction through the shaking table, thereby changing relative positions of the first chamber and the second chamber; and since the flexible chamber is connected between the first chamber and the second chamber, the flexible chamber deforms and moves for dislocation of the first chamber and the second chamber, and relative positions of the flexible fault connecting units of the flexible chamber change, thereby driving roller assemblies under the flexible chamber to slide on slide rails at different degrees, and enabling a fault fracture zone (FFZ) of the tested soil in the flexible chamber to deform and fracture, thus realizing high-geostress strike-slip fault simulating experimental research in the water-rich environment.

Both a high geostress test device and a fault simulating test device are important in the field of civil engineering. The two test devices are not contradictory or conflicting to each other. In cooperation with the two test devices, the fault simulating test of the tested soil under a high geostress can be realized, and the experimental research in more complex conditions can be completed.

The present disclosure has following beneficial effects:

The whole test chamber in the present disclosure is fully sealed. Before the test, the water can be injected to create the water-rich environment, which can realize the experimental research in the water-rich environment better.

According to the present disclosure, the first chamber, the second chamber and the flexible chamber each are the cylindrical chamber having the tail end provided with a hemispherical structure, such that the tested soil can adapt to higher-intensity pressurization, increasing a tolerable range of the test chamber to realize the more difficult experimental research.

According to the present disclosure, the flexible chamber includes a plurality of flexible fault connecting units. The framework flanges are configured to connect the plurality of flexible fault connecting units. The rubber ring is able to realize axial tensile deformation and horizontal shear deformation, as well as a sealing function in case of a pressure. The nested steel plate is configured to restrict expansive deformation of the rubber ring under the pressure. The flexible chamber can intuitively reflect a condition of the FFZ under the high geostress.

According to the present disclosure, the roller assembly under the flexible chamber offers an upward supporting force for the flexible chamber, solving the falling problem of the flexible chamber for a weight of the tested soil. Moreover, through cooperation between the roller assembly and the slide rail, the flexible chamber can move in the horizontal direction when dislocated. The roller assembly can adapt to dislocation of the shaking table well, causing deformation and movement of the flexible fault connecting units of the flexible chamber. Meanwhile, a moving distance of each roller assembly also reflects the condition of the FFZ.

Therefore, the present disclosure can realize the experimental research on the high geostress and active fault in more complex conditions.

### BRIEF DESCRIPTION OF THE DRAWINGS

FIG. 1 is an overall schematic structural view according to the present disclosure;

FIG. 2 is a top schematic structural view according to the present disclosure;

FIG. 3 is a schematic structural view of a first chamber and a second chamber;

FIG. 4 is an overall schematic structural view of a flexible chamber;

FIG. 5 is a partial schematic sectional view of a flexible chamber;

FIG. 6 is an overall schematic structural view of a support assembly;

FIG. 7 is an overall schematic structural view of a roller assembly;

FIG. 8 is a schematic view of an assembly state of a roller assembly on a flexible chamber;

FIG. 9 is a schematic view of an assembly state for a roller assembly and a slide rail;

FIG. 10 is an overall schematic structural view of the present disclosure in a test state; and

FIG. 11 is a partial schematic structural view of a flexible chamber in a test state.

### REFERENCE NUMERALS

1: first chamber, 11: gas connection opening, 12: water connection opening, 2: second chamber, 3: flexible chamber, 31: rubber ring, 32: steel plate, 33: framework flange, 4: support assembly, 41: support frame, 42: base frame, 43: circular opening, 44: reinforcing rib plate, 5: roller assembly, 51: roller, 511: roller body, 512: retainer ring, 52: side frame, 53: roller shaft, 6: slide rail, 7: base, and 8: bolt device.

### DETAILED DESCRIPTION OF THE EMBODIMENTS

The technical solutions in the embodiments of the present disclosure are clearly and completely described below with reference to the drawings in the embodiments of the present disclosure. Apparently, the described embodiments are merely a part rather than all of the embodiments of the present disclosure. All other embodiments obtained by those of ordinary skill in the art based on the embodiments of the present disclosure without creative efforts should fall within the protection scope of the present disclosure.

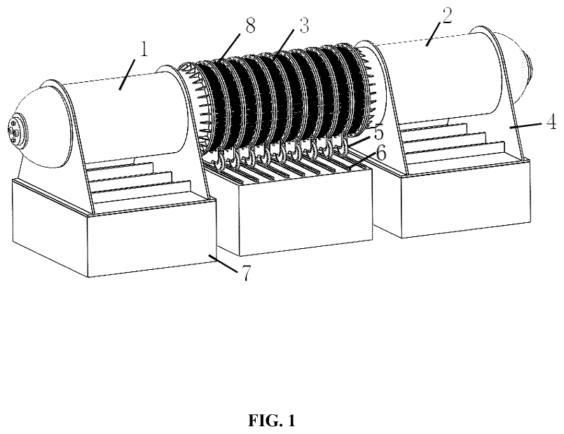

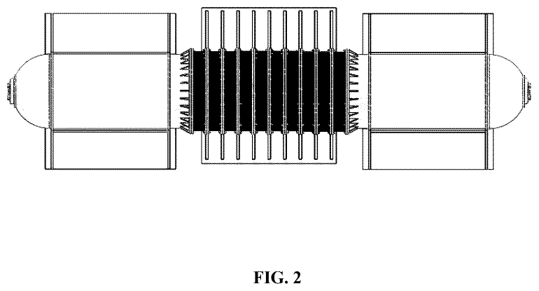

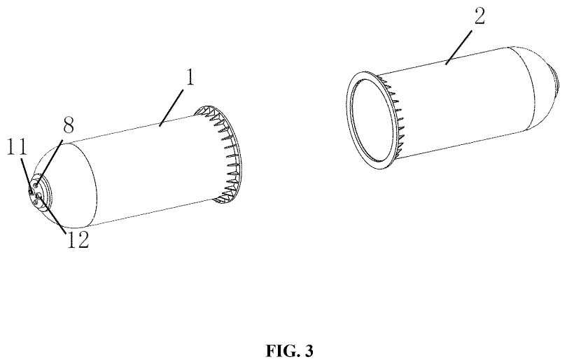

As shown in FIG. 1, FIG. 2 and FIG. 3, the present disclosure provides a water-rich high-geostress strike-slip fault simulating test chamber, which is used to carry out a high-geostress strike-slip fault simulating test. The present disclosure may employ a shaking table test device in seismic simulation to carry out a fault simulating test on tested soil. The present disclosure includes a first chamber 1, a second chamber 2, a flexible chamber 3, a support assembly 4, a roller assembly 5, a slide rail 6, a base 7, and a bolt device 8. The first chamber 1 and the second chamber 2 each are fixed on the respective underlying base 7 through the support assembly 4. An open end of the first chamber 1 and an open end of the second chamber 2 are opposite to each other and are disposed at a certain distance. Two ends of the flexible chamber 3 are open. The flexible chamber 3 is fixed at a horizontal opening between the first chamber 1 and the second chamber 2 through the bolt device 8, and communicates with the first chamber 1 and the second chamber 2 to jointly define a tested soil filling area. An FFZ of the tested soil is located in the flexible chamber 3. The roller assembly 5 is disposed under the flexible chamber 3. The roller assembly 5 moves in cooperation with the slide rail 6 on its underlying base 7, thereby meeting test requirements for simulating an active fault in a water-rich high-geostress condition.

As shown in FIG. 3, the first chamber 1 and the second chamber 2 each are a structure with one end hemispherical and sealed and the other end truncated and open, and include an opening provided with a flange. Both the first chamber 1 and the second chamber 2 have a same size, are a quasi-cylindrical chamber, and are horizontally placed at a same height. A gas connection opening 11 and a water connection opening 12 are fixed to the hemispherical sealed end of each of the first chamber and the second chamber through the bolt device 8. An interior of the chamber is pressurized by a gas pump through the gas connection opening 11. Through the water connection opening 12, water is injected into the chamber to create a water-rich environment.

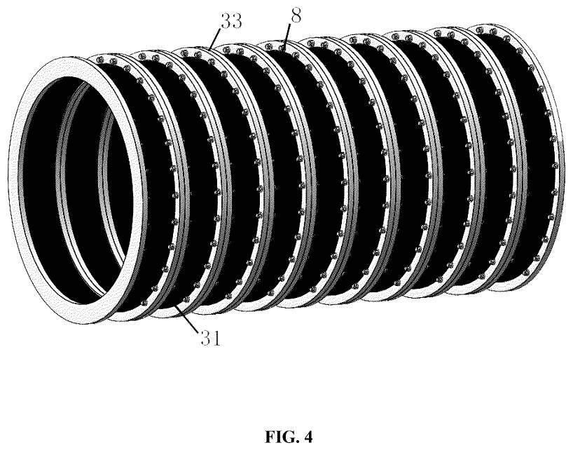

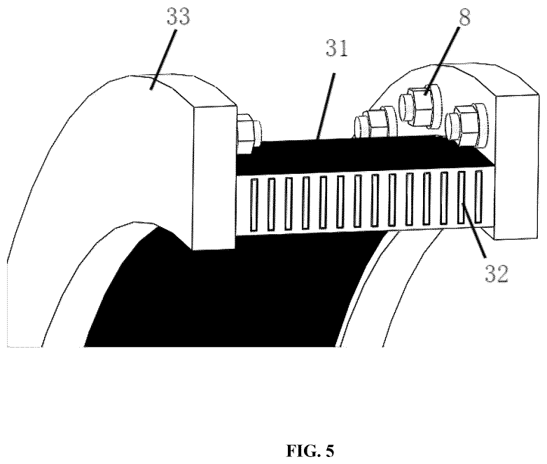

As shown in FIG. 4 and FIG. 5, the flexible chamber 3 is a cylindrical chamber. The flexible chamber 3 includes a rubber ring 31, a steel plate 32 nested in the rubber ring, and framework flanges 33. Two sides of the rubber ring 31 are respectively fixedly connected to the framework flanges 33. A plurality of nested steel plates 32 are disposed in the rubber ring 31. The rubber ring 31, the framework flanges 33 at the two sides of the rubber ring 31, and the steel plate 32 in the rubber ring 31 define a flexible fault connecting unit. A plurality of flexible fault connecting units are formed into the flexible chamber 3 by connecting the framework flanges 33 with the bolt device 8. The framework flanges 33 are configured to connect the plurality of flexible fault connecting units. The rubber ring 31 is able to realize axial tensile deformation and horizontal shear deformation, as well as a sealing function in case of a pressure. The steel plate 32 is configured to restrict expansive deformation of the rubber ring 31 under the pressure. The flexible chamber 3 can intuitively reflect a condition of the FFZ under a high geostress.

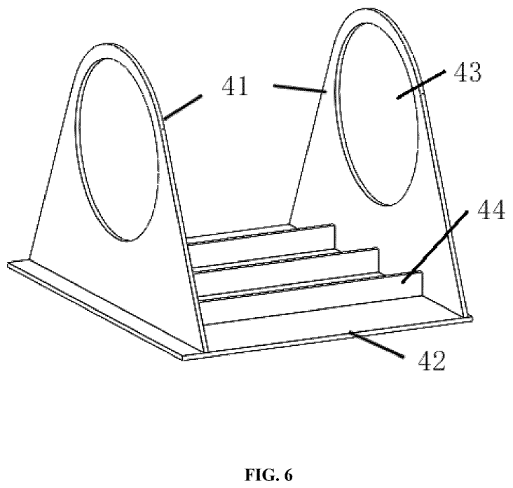

As shown in FIG. 6, the support assembly 4 includes a support frame 41 and a base frame 42. The support frame 41 has a rectangular section with an arc at a vertex. A circular opening 43 is formed in an arc region of the support frame 41. A size of the circular opening 43 is slightly greater than a sectional size of the first chamber 1 and a sectional size of the second chamber 2. The first chamber 1 and the second chamber 2 each are fixed on the support frame 41 through the circular opening. The two chambers each are provided with two support frames 41 at an interval. The two support frames 41 on the same chamber are respectively located at the sealed end and the open end of the chamber. The base frame 42 is located under the support frame 41. The two support frames 41 and one base frame 42 are formed into the support assembly 4. A reinforcing rib plate 44 is disposed on the base frame 42 between the two support frames 41. The support assembly 4 is fixed on the base 7.

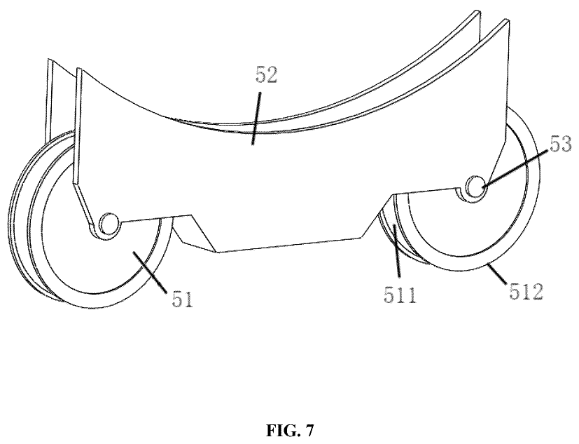

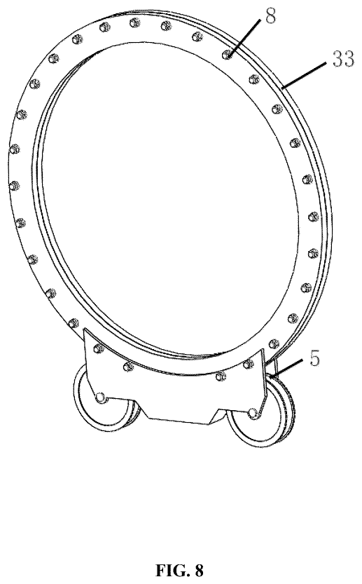

As shown in FIG. 7 and FIG. 8, the roller assembly 5 includes a roller 51, a side frame 52, and a roller shaft 53. The roller 51 includes a roller body 511 and a retainer ring 512. The retainer ring 512 is disposed at two ends of a circumferential surface of the roller body 511, forming a groove in a middle of a tread. A shaft hole is formed in a center of the roller 51. An overall section of the side frame 52 is combined by a circular arc and a trapezoid. A left bottom and a right bottom of the section of the side frame 52 each are provided with a shaft hole. The shaft hole in the side frame 52 and the shaft hole in the roller 51 have a same size and overlap each other. The roller shaft 53 passes through the two shaft holes, such that the roller is disposed on the side frame. Two rollers 51, one side frame 52 and two roller shafts 53 are formed into one roller assembly 5. An upper arc region of the section of the side frame 52 is connected to two sides of the framework flange 33 of the flexible chamber through the bolt device 8. The two rollers 51 are collinearly disposed at a front side and a rear side of a bottom of the framework flange 33 and located in a lower trapezoidal region of the section of the side frame 52.

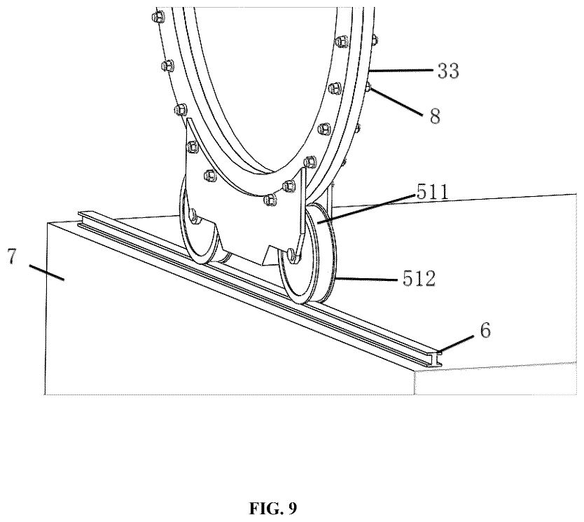

As shown in FIG. 9, the slide rail 6 is an I-shaped steel slide rail. The roller body 511 of the roller body 51 comes in contact with the slide rail 6. The retainer ring 512 of the roller 51 is located at two outer sides of the slide rail 6. The slide rail 6 is fixed on the base 7. The number of slide rails 7 is the same as the number of roller assemblies 51. The roller assembly 5 can move linearly in a horizontal direction on the slide rail 6.

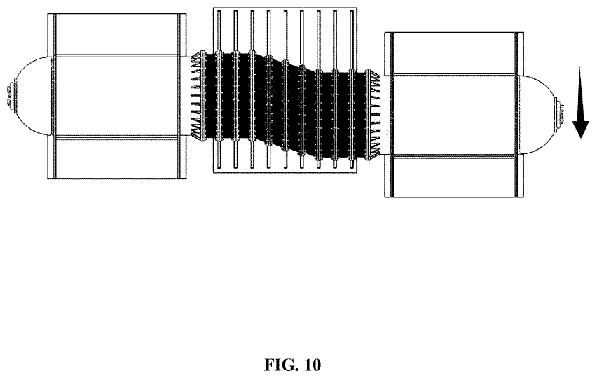

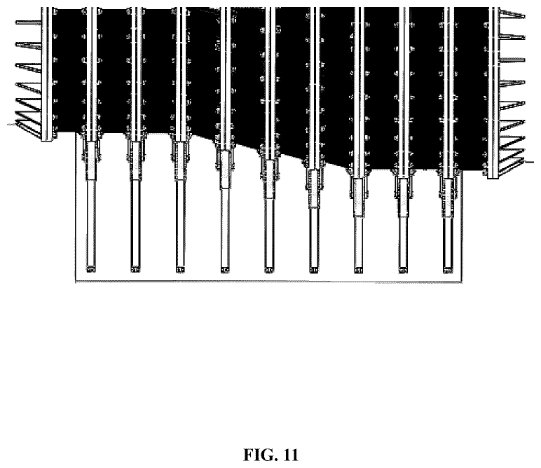

As shown in FIG. 10 and FIG. 11, in response to filling of the tested soil, the first chamber is erected through a hoisting beam. The tested soil is filled from the opening of the first chamber. The flexible chamber and the second chamber are disposed in sequence. Upon completion of the filling, the whole test chamber is sealed fully, and horizontally placed on the shaking table for a test. The base under the first chamber and the base under the flexible chamber are fixed, while the base under the second chamber is disposed on the shaking table. The gas pump may be connected to the gas connection opening 11 to fill the gas to the chamber, thereby pressurizing the tested soil. The water may also be injected into the chamber through the water connection opening 12, thereby creating the water-rich environment.

During the test, the base 7 under the second chamber 2 moves in a horizontal direction through the shaking table, and the base of the first chamber 1 is fixed, thereby changing relative positions of the first chamber and the second chamber. Since the flexible chamber 3 is connected between the first chamber 1 and the second chamber 2, the flexible chamber 3 deforms and moves for dislocation of the first chamber 1 and the second chamber 2, and relative positions of the flexible fault connecting units of the flexible chamber change, thereby driving roller assemblies 5 under the flexible chamber 3 to slide on slide rails 6 at different degrees, and enabling the FFZ of the tested soil in the flexible chamber to deform and fracture, thus realizing high-geostress strike-slip fault simulating experimental research in the water-rich environment.

It is apparent for those skilled in the art that the present disclosure is not limited to details of the above exemplary embodiments, and that the present disclosure may be implemented in other specific forms without departing from spirit or basic features of the present disclosure. Therefore, the embodiments should be considered illustrative and nonrestrictive in every respect.

What is claimed is:

1. A water-rich high-geostress strike-slip fault simulating test chamber, comprising: a first chamber and a second chamber, wherein a flexible chamber is fixedly connected between the first chamber and the second chamber; the flexible chamber internally communicates with the first chamber and the second chamber; the flexible chamber comprises a plurality of flexible fault connecting units; each of the flexible fault connecting units comprises framework flanges, a rubber ring, and a steel plate nested in the rubber ring; the framework flanges are respectively fixed at two axial sides of the rubber ring; and two adjacent flexible fault connecting units are connected through a bolt device fixed on two adjacent framework flanges; and
a base is disposed under each of the first chamber, the second chamber and the flexible chamber; a roller assembly is jointly disposed under every two adjacent framework flanges in the flexible chamber; the roller assembly comprises at least one roller; a slide rail is disposed on the base disposed under the flexible chamber; the slide rail is in one-to-one correspondence with the roller assembly; and the roller in the roller assembly is mated with the slide rail.

2. The water-rich high-geostress strike-slip fault simulating test chamber according to claim 1, wherein the first chamber and the second chamber have an identical structure, and each is a quasi-cylinder with one hemispherical sealed end and a truncated open end; the open end is fixedly connected to a flange connected to the flexible chamber; the sealed end is provided with a gas connection opening and a water connection opening that communicate with an interior of the quasi-cylinder; the gas connection opening is configured to connect with an external gas pump to pump a gas into the quasi-cylinder for pressurization; and from the water connection opening is configured to connect with an external water source to inject water into the quasi-cylinder.

3. The water-rich high-geostress strike-slip fault simulating test chamber according to claim 2, wherein the first chamber and the second chamber each are disposed on the respective base through a support assembly; and the support assembly comprises two support frames respectively disposed at the sealed end and the open end and a base frame connected to the two support frames.

4. The water-rich high-geostress strike-slip fault simulating test chamber according to claim 2, wherein the roller assembly further comprises a side frame; an upper portion of the side frame is shaped as an arc matching with a radian of each framework flange, and fixedly connected to the framework flange through the bolt device in an arc region; and a plurality of rollers are collinearly disposed on a lower portion of the side frame.

5. The water-rich high-geostress strike-slip fault simulating test chamber according to claim 4, wherein the slide rail has an I-shaped cross-section; a groove is formed in a tread of each roller; and an upper end of the slide rail is embedded into the groove of the roller, such that the roller moves linearly in a horizontal direction along the slide rail.

6. The water-rich high-geostress strike-slip fault simulating test chamber according to claim 1, wherein the steel plate extends vertically in the rubber ring.
